(19) United States
(12) Patent Application Publication
(10) Pub. No.: US 2022/0334259 A1
(43) Pub. Date: Oct. 20, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: MASATAKA TOYOURA, TOKYO (JP); KEISUKE TSUDAKA, TOKYO (JP)

(21) Appl. No.: 17/763,347

(22) PCT Filed: Aug. 11, 2020
(86) PCT No.: PCT/JP2020/030584

§ 371 Date: Mar. 24, 2022

(30) Foreign Application Priority Data
Oct. 3, 2019 (JP) 2019-183058

(51) Int. Cl. G01S 17/89; G01S 17/86; G01S 17/931

(52) U.S. Cl. CPC G01S 17/89; G01S 17/86; G01S 17/931

(57) ABSTRACT

To provide an information processing apparatus, an information processing method, and a program that are capable of continuingly generating a self-position also in a featureless environment, that is, an environment where a movable object moves and which has no features. An information processing apparatus includes a first self-position identification unit and an evaluation unit. The first self-position identification unit identifies a first self-position of a movable object on the basis of first sensing data. The evaluation unit evaluates whether or not each component of the identified first self-position is valid.

### TECHNICAL FIELD

The present technology relates to an information processing apparatus, an information processing method, and a program associated with autonomous driving of a movable object such as an automobile and a robot.

### BACKGROUND ART

In autonomous driving of a movable object such as an automobile and a robot, it is typical to perform self-position identification by using a three-dimensional point cloud acquired by light detection and ranging (LiDAR) or the like to perform matching with a map prepared in advance or using the three-dimensional point cloud to perform simultaneous localization and mapping (SLAM).

However, if an environment where the movable object moves has no prominent features, matching may not be performed correctly and the self-position identification may fail. Moreover, an incorrect self-position may be identified even though matching is perfectly established.

Patent Literature 1 has described a self-position estimation method of a robot for preventing a situation where the accuracy of the position estimation (position identification) is low, which is caused in a case where the environment where the robot moves has no features.

In the invention described in Patent Literature 1, simulations are used to calculate a self-position estimation easiness parameter indicating easiness (difficulty) of the self-position estimation, which corresponds to each block of map data and results from environment and topography, and the calculated self-position estimation easiness parameter is presented to a user. Based on the presented self-position estimation easiness parameter, the user performs an action to make the self-position estimation easy, e.g., placing an obstacle on a featureless corridor or the like.

### CITATION LIST

### Patent Literature

Patent Literature 1: Japanese Patent Application Laid-open No. 2012-141662

### DISCLOSURE OF INVENTION

### Technical Problem

In Patent Literature 1, the robot is incapable of determining in real time a situation where the accuracy of the self-position identification lowers, and it is necessary to anticipate the situation where the accuracy lowers by simulations or the like in advance.

In view of the above-mentioned circumstances, it is an object of the present technology to provide an information processing apparatus, an information processing method, and a program that are capable of continuingly generating a self-position also in a featureless environment, that is, an environment where a movable object moves and which has no features.

### Solution to Problem

An information processing apparatus according to an embodiment of the present technology includes a first self-position identification unit and an evaluation unit.

The first self-position identification unit identifies a first self-position of a movable object on the basis of first sensing data.

The evaluation unit evaluates whether or not each component of the identified first self-position is valid.

With such a configuration, valid one of the components of the identified first self-position can be determined.

The information processing apparatus may further include a self-position generation unit that employs a component evaluated to be valid by the evaluation unit and generates a final self-position of the movable object.

The information processing apparatus may further include a second self-position identification unit that identifies a second self-position of the movable object on the basis of the second sensing data different from the first sensing data, in which the self-position generation unit replaces the component determined to be invalid by the evaluation unit with a component of the second self-position identified by the second self-position identification unit and generates the final self-position of the movable object.

The first sensor that outputs the first sensing data and the second sensor that outputs the second sensing data may be different from each other.

The second sensor may have higher robustness in a featureless environment than the first sensor.

The second sensor may be an internal sensor mounted on the movable object.

The first sensor may be light detection and ranging (LiDAR) mounted on the movable object.

The first self-position identification unit may identify the first self-position on the basis of a matching processing result between a point cloud of a surrounding environment of the movable object, which is the first sensing data, and a point cloud for matching, which is acquired in advance.

The evaluation unit may evaluate whether or not each component of the first self-position is valid by using the matching processing result.

The evaluation unit may discard a component evaluated to be invalid.

An information processing apparatus according to an embodiment of the present technology includes a first module, a second module, a third module, and a self-position generation unit.

The first module includes a first self-position identification unit that identifies a first self-position of a movable object on the basis of a first sensing data and a first evaluation unit that evaluates whether or not each component of the identified first self-position is valid.

The second module includes a second self-position identification unit that identifies the second self-position of the movable object on the basis of the second sensing data.

The third module includes a third self-position identification unit that identifies a third self-position of the movable object on the basis of the third sensing data and a third evaluation unit that evaluates whether or not each component of the identified third self-position is valid.

The self-position generation unit generates the final self-position of the movable object by using evaluation results of the first evaluation unit and the third evaluation unit, the first self-position, the second self-position, and the third self-position.

An information processing apparatus according to an embodiment of the present technology includes a second module, a first module, and a third module.

The second module includes a second self-position identification unit that identifies a second self-position of a movable object on the basis of second sensing data.

The first module includes a first self-position identification unit that identifies the first self-position of the movable object on the basis of first sensing data, a first evaluation unit that evaluates whether or not each component of the identified first self-position is valid, and a self-position generation unit that generates a self-position of the movable object by using an evaluation result of the first evaluation unit, the first self-position, and the second self-position.

The third module includes a third self-position identification unit that identifies the third self-position of the movable object on the basis of the third sensing data, a third evaluation unit that evaluates whether or not each component of the identified third self-position is valid, and a self-position generation unit that generates the final self-position of the movable object by using an evaluation result of the third evaluation unit, the third self-position, and a self-position generated by the first module.

The first sensor that outputs the first sensing data, the second sensor that outputs the second sensing data, and a third sensor that outputs the third sensing data may be different from one another.

The first sensor may be light detection and ranging (LiDAR) mounted on the movable object, the second sensor is an internal sensor mounted on the movable object, and the third sensor is a camera mounted on the movable object.

An information processing method according to an embodiment of the present technology includes: identifying a first self-position of a movable object on the basis of first sensing data; and evaluating whether or not each component of the identified first self-position is valid.

A program according to an embodiment of the present technology causes an information processing apparatus to execute processing including the steps of: identifying a first self-position of a movable object on the basis of first sensing data; and evaluating whether or not each component of the identified first self-position is valid.

### BRIEF DESCRIPTION OF DRAWINGS

FIG. 1 A block diagram showing functional configurations of an information processing apparatus according to a first embodiment of the present technology.

FIG. 2 A flow diagram describing a self-position identification method (information processing method) using the information processing apparatus.

FIG. 3 A diagram describing examples of an environment in which a movable object is placed.

FIG. 4 A diagram describing examples of an environment in which the movable object is placed.

FIG. 5 A diagram describing examples of a three-dimensional point cloud of a matching target.

FIG. 6 A diagram describing examples of a three-dimensional point cloud that is observed by a LiDAR mounted on the movable object.

FIG. 7 A diagram describing matching between the three-dimensional point cloud of the matching target shown in FIG. 5 and the observed three-dimensional point cloud shown in FIG. 6.

FIG. 8 A block diagram showing functional configurations of an information processing apparatus according to a second embodiment.

FIG. 9 A block diagram showing functional configurations of an information processing apparatus according to a third embodiment.

### MODE(S) FOR CARRYING OUT THE INVENTION

In identifying a self-position of a movable object by using sensing data from multiple sensors that have different robustness against environmental changes, an information processing apparatus according to the present technology takes the surrounding environment of the movable object into consideration and determines from which sensor the sensing data is to be employed for each component.

Accordingly, even if the movable object is placed in a featureless environment, it is possible to continuingly generate a self-position of the movable object. Hereinafter, it will be described in detail using embodiments.

Hereinafter, a four-wheeled vehicle (hereinafter, simply referred to as vehicle) will be exemplified as the movable object. A control unit that performs a series of processing for self-position identification is provided in the vehicle and the vehicle functions as an information processing apparatus.

### First Embodiment

[Configuration of Vehicle (Information Processing Apparatus)]

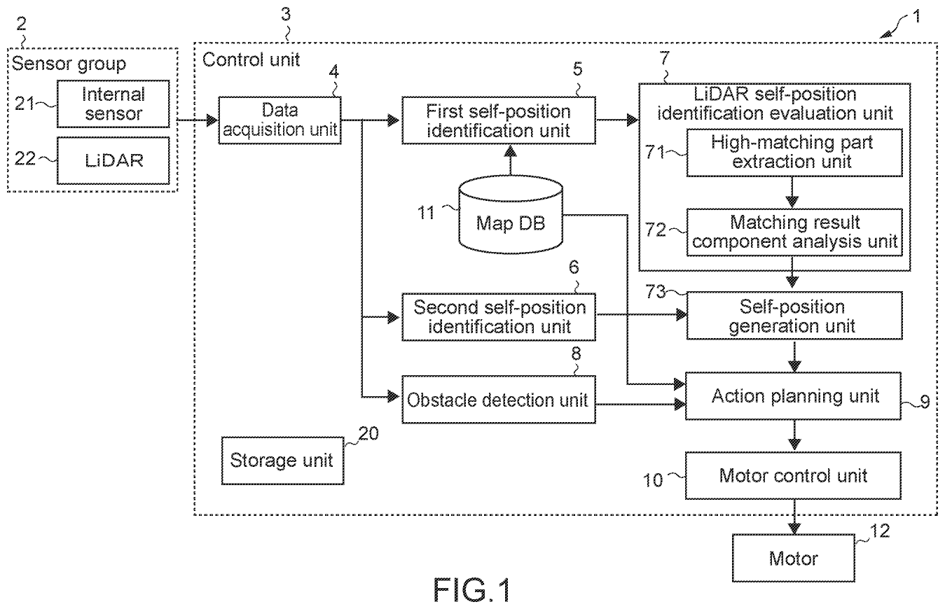

A vehicle 1 as an information processing apparatus according to an embodiment of the present technology will be described with reference to FIG. 1. FIG. 1 is a block diagram showing functional configurations of the vehicle 1.

As shown in FIG. 1, the vehicle 1 includes a sensor group 2, a control unit 3, and a motor 12.

In accordance with various programs stored in a storage unit 20 to be described later, the control unit 3 generates a self-position of the vehicle 1, and controls the movement of the vehicle 1 by using the generated self-position. It will be described in detail later.

The sensor group 2 acquires a state (internal information) of the vehicle 1 itself and peripheral environment information of the vehicle 1.

The sensor group 2 includes an internal sensor 21, a radar using an echo-localization method such as a light detection and ranging (LiDAR) 22, and the like.

The internal sensor 21 as a second sensor is a sensor for obtaining the state (internal information) of the vehicle 1 itself.

The internal sensor 21 includes an inertial measurement unit (abbreviated as IMU), a wheel encoder, a gyro sensor, an acceleration sensor, and the like. Here, an IMU and a wheel encoder will be described as examples of the internal sensor 21.

Output values of the wheel encoder as second sensing data include information regarding a moving direction of the vehicle 1, an amount of movement, a rotation angle, and the like. Output values of the IMU as the second sensing data include information regarding a three-dimensional angular velocity, acceleration, and the like of the vehicle 1.

The LiDAR 22 as a first sensor is a sensor for obtaining surrounding environmental information of the vehicle 1 and, for example, is installed in the vehicle 1 so as to be capable of omni-directional detection.

The LiDAR 22 is provided, for example, in a front nose, a rear bumper, and a back door of the vehicle and an upper part of a windshield in a vehicle compartment. The LiDAR 22 is mainly used for detecting preceding vehicles, pedestrians, obstacles, and the like.

The vehicle 1 is capable of detecting objects (hereinafter, sometimes referred to as features) such as vehicles, people, and walls that are present in the surrounding environment of the vehicle by using a sensor that recognizes the surroundings such as the LiDAR 22. The LiDAR 22 is capable of detecting a distance, an orientation, and the like from the vehicle 1 to an object by using a laser beam. A pulse type, a frequency modulated continuous wave (FMCW) method, or the like is typically used for detecting.

Output values of the LiDAR 22 as first sensing data are data associated with reflected waves of laser beams and include the distance information from the vehicle 1 to the object. For example, on the basis of the output values of the LiDAR mounted on the vehicle 1, the shape of a feature such as a wall around the vehicle 1 can be observed as a three-dimensional point cloud and the object can be detected.

The internal sensor 21 has a lower self-position identification accuracy than the LiDAR 22 while the internal sensor 21 has higher robustness against environmental changes than the LiDAR 22.

The second sensing data output from the internal sensor 21 is data having less changes due to surrounding environmental changes than the first sensing data output from the LiDAR 22. On the other hand, since errors in the second sensing data output from the internal sensor 21 are accumulated along with the traveling distance, the self-position identification accuracy is lower. For example, in a case where it is desired to cause the vehicle to perform the same operation in the same environment for a long time, the second sensing data alone is insufficient for the self-position identification.

The LiDAR 22 has a higher self-position identification accuracy than the internal sensor 21 while the LiDAR 22 has robustness lower than the internal sensor 21.

The LiDAR 22 is typically mounted outside the vehicle. For example, when it is raining or snowing, the LiDAR 22 may incorrectly detect a distance to an object (feature) to be observed because a laser beam output from the LiDAR 22 is reflected on rain or snow particles. It should be noted that in a case where the LiDAR 22 is installed in the interior of the vehicle, a laser is attenuated by the glass, so it is difficult to detect a reflected light from the observed object.

Thus, data obtained from the LiDAR 22 is easily affected by environmental changes such as weather effects.

In addition, in a case where the environment where the vehicle 1 moves is a featureless environment, when performing the self-position identification of the vehicle by matching processing between a three-dimensional point cloud observed by the LiDAR 22 and a three-dimensional point cloud of a matching target, the self-position identification may be incorrectly performed even though matching is established. Thus, the LiDAR 22 has lower robustness than the internal sensor 21 in the featureless environment.

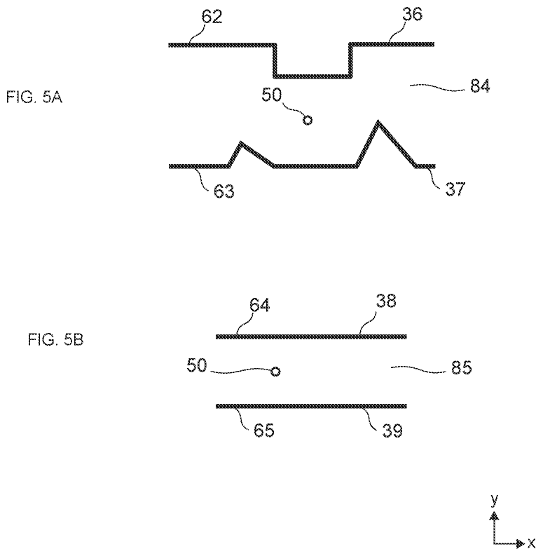

Hereinafter, an example in which incorrect self-position identification is performed even though matching is established in the featureless environment will be described with reference to FIGS. 5 to 7.

FIGS. 5 to 7 are schematic diagrams describing self-position identification in each of an environment with features and an environment with small features. FIGS. 5 to 7 are all diagrams of a road as viewed from above.

It should be noted that in the present specification, the horizontal plane is defined as an XY plane. The X-axis, Y-axis, and Z-axis are orthogonal to one another.

In the examples shown in FIGS. 5 to 7, the traveling direction of the vehicle is a direction from the left to the right in the figure and is equivalent to a positive X-axis direction. The terms “left and right” to be described below are equivalent to the left and right as the vehicle is oriented to the traveling direction.

Here, the self-position identification of the vehicle is performed by performing matching processing between the three-dimensional point cloud observed in the LiDAR and the three-dimensional point cloud of the matching target prepared in advance. It should be noted that the self-position may be identified by using a SLAM accumulation result. In this case, matching is performed while changing the position and attitude of the currently acquired point cloud by using the position at which the self-position was detected in the past as the base point. Finally, a position at which the degree of matching exceeds a predetermined threshold is identified as the self-position.

In the self-position identification, a situation where the self-position is incorrect even though a result has been obtained at a high matching rate may occur in an environment where matching is established at a plurality of parts.

FIGS. 5 (A) and (B) show a three-dimensional point cloud of a matching target acquired and prepared in advance or a three-dimensional point cloud of a matching target when the self-position was detected in the past.

FIG. 5 (A) shows an environment with features where the shape of a road 84 is not straight and left and right walls 62 and 63 on opposite sides of the road 84 each have a curved shape. The three-dimensional point cloud of the matching target representing the left wall 62 is denoted by the reference sign 36 and the three-dimensional point cloud of the matching target representing the right wall 63 is denoted by the reference sign 37. The three-dimensional point cloud of the matching target is a point cloud acquired when the vehicle is located at a position 50.

FIG. 5 (B) shows an environment with small features where the shape of a road 85 is straight and left and right walls 64 and 65 on opposite sides of the road 85 extend in a straight line and are arranged in parallel. The three-dimensional point cloud of the matching target representing the left wall 64 is denoted by the reference sign 38 and the three-dimensional point cloud of the matching target representing the right wall 65 is denoted by the reference sign 39. The three-dimensional point cloud of the matching target is a point cloud acquired when the vehicle is located at the position 50.

In FIG. 5, the reference sign 50 denotes a self-position acquired in advance or a self-position identified in the past. It should be noted that in this embodiment, the description will be given by using an example in which a map including a three-dimensional point cloud for matching is acquired in advance and is stored in a map DB (database) 11.

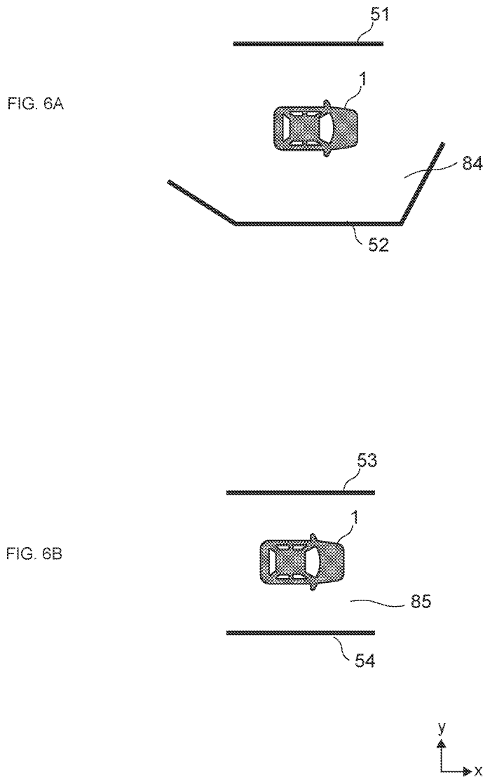

FIG. 6 (A) shows three-dimensional point clouds 51 and 52 observed in the LiDAR 22 mounted on the vehicle 1 traveling on the road 84 shown in FIG. 5 (A). In the example shown in FIG. 6 (A), the three-dimensional point cloud 51 located on the left side has a straight shape and the three-dimensional point cloud 52 located on the right side has a curved shape.

FIG. 6 (B) shows three-dimensional point clouds 53 and 54 observed in the LiDAR 22 mounted on the vehicle 1 traveling on the road 85 shown in FIG. 5 (B). In the example shown in FIG. 6 (B), the three-dimensional point cloud 53 located on the right side and the three-dimensional point cloud 54 located on the left side both have a straight shape.

It should be noted that the three-dimensional point cloud of the matching target at the time of the matching processing shown in FIG. 5 is referred to as the “three-dimensional point cloud of the matching target” and the three-dimensional point cloud acquired by the LiDAR 22 mounted on the vehicle 1 is sometimes referred to as the “observed three-dimensional point cloud” and described.

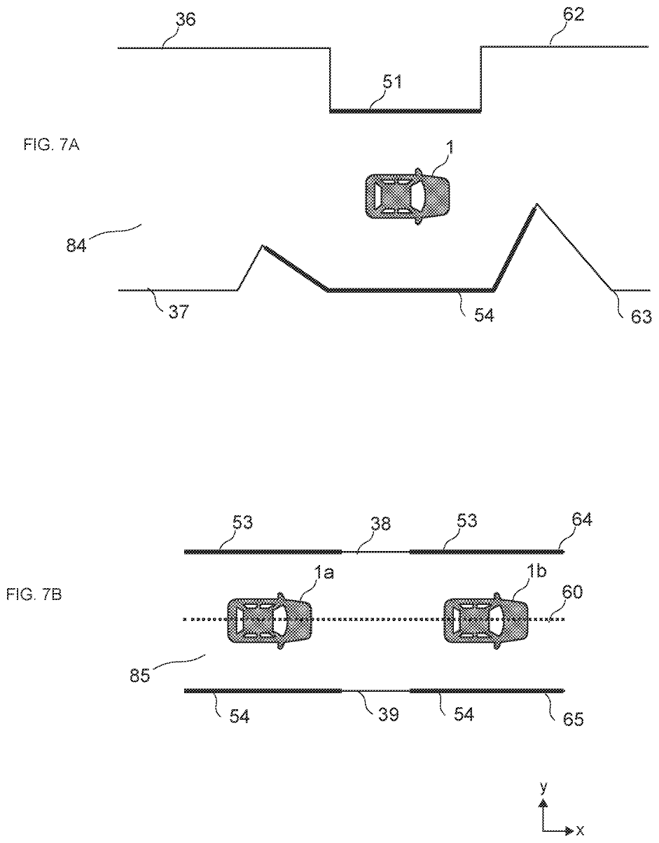

FIG. 7 (A) shows results of matching the three-dimensional point clouds of the matching targets shown in FIG. 5 (A) and FIG. 6 (A) respectively and the observed three-dimensional point clouds. FIG. 7 (B) shows results of matching the three-dimensional point clouds of the matching targets shown in FIG. 5 (B) and FIG. 6 (B) respectively and the observed three-dimensional point clouds.

In FIGS. 7 (A) and (B), three-dimensional point clouds 36 to 39 of the matching targets are represented by the thin solid lines and the observed point clouds 51 to 54 are represented by the thick solid lines. In the parts where the thick solid lines are located, the thin solid lines overlap, and the thin solid lines do not appear in the figure. In FIG. 7 (B), the extending direction of the vehicle and the traveling direction of the road 85 are parallel, and a virtual broken line 60 is parallel to the extending direction of the road 85.

As shown in FIG. 7A, in the environment with features, the matching coordinates are determined at a single part, and therefore the self-position of the vehicle 1 can be correctly identified.

On the other hand, as shown in FIG. 7 (B), in the environment with small features, matching is established also in a vehicle 1a and a vehicle 1b that are located at different positions on the broken line 60. In the example shown in FIG. 7 (B), all vehicles located on the broken line 60 show perfect matching results, and the matching coordinates are not determined at a single part. Therefore, the vehicle 1 may be incorrectly detected as having stopped even though it is moving forward or may be incorrectly detected as being moving forward even though it has stopped. Thus, incorrect self-position identification may be performed even though the result was obtained at a high matching rate at the time of matching processing.

It should be noted that in the present specification, the “featureless environment” refers to an environment where the coordinates are not determined at a single part and matching is established at a plurality of parts in matching processing as in the example shown in FIG. 7B.

In contrast, in the present technology, the surrounding environment of the vehicle 1 is taken into consideration, from which sensor the sensing data is to be employed is determined for each component of the self-position, and a final self-position of the vehicle 1 is generated.

Specifically, in the example shown in FIG. 7B, in identifying the final self-position of the vehicle, a plurality of solutions in an X-axis component exists while a Y-axis component and a yaw-axis rotation component are uniquely determined in the matching processing.

In such a case, Y-axis component and yaw-axis rotation component of a first self-position identified on the basis of the outputs of the LiDAR 22 are regarded as valid, and are employed as Y-axis component and yaw-axis rotation component of a final self-position.

On the other hand, an X-axis component of the first self-position identified on the basis of the outputs of the LiDAR 22 is regarded as invalid, and is not employed as an X-axis component of the final self-position and is discarded. Then, an X-axis component of a second self-position identified on the basis of the output of the internal sensor 21, which is another sensor different from the LiDAR 22, is employed as the X-axis component of the final self-position, and a final self-position of the vehicle 1 is generated.

It will be described in detail later.

The motor 12 is a driving unit that drives the wheels of the vehicle 1. The motor 12 is driven on the basis of a control signal generated by a motor control unit 10.

(Configuration of Control Unit)

As shown in FIG. 1, the control unit 3 includes a data acquisition unit 4, a first self-position identification unit 5, a second self-position identification unit 6, a LiDAR self-position identification evaluation unit 7, a self-position generation unit 73, an obstacle detection unit 8, an action planning unit 9, a motor control unit 10, a map DB 11, and a storage unit 20.

The data acquisition unit 4 acquires second sensing data output from the internal sensor 21 and first sensing data output from the LiDAR 22.

The acquired first sensing data (data output from the LiDAR) is output to the first self-position identification unit 5.

The acquired second sensing data (data output from the internal sensor) is output to the second self-position identification unit 6.

The second self-position identification unit 6 identifies the second self-position of the vehicle 1 on the basis of the second sensing data acquired by the data acquisition unit 4 (data output from the internal sensor). The identification result of the second self-position is output to the self-position generation unit 73.

The first self-position identification unit 5 identifies the first self-position of the vehicle 1 on the basis of the first sensing data acquired by the data acquisition unit 4 (data output from the LiDAR).

More particularly, as described above with reference to FIGS. 5 to 7, the first self-position identification unit 5 performs exhaustive matching processing on the three-dimensional point cloud observed by the LiDAR 22 and the three-dimensional point cloud of the matching target stored in the map DB 11 in the search area to identify the first self-position of the vehicle 1.

The matching processing result and the first self-position information are output to the LiDAR self-position identification evaluation unit 7.

The first self-position and the second self-position include roll-axis rotation components, pitch-axis rotation components, yaw-axis rotation components, and the like related to attitude information as well as X-axis components, Y-axis components, and Z-axis components related to the position information.

It should be noted that in the vehicle traveling on the ground, the self-position may be expressed two-dimensionally by mainly using the X-axis component and the Y-axis component as the position information and mainly using the yaw-axis rotation component as the attitude information.

The first self-position identification unit 5 and the second self-position identification unit 6 each identify the self-position of the vehicle 1 by using sensing data output for each different sensor.

The LiDAR self-position identification evaluation unit 7 as an evaluation unit evaluates whether or not the component of the first self-position is valid for each component on the basis of the result of the matching processing performed in identifying the first self-position of the vehicle 1 by the first self-position identification unit 5. It will be described in detail later.

The self-position generation unit 73 generates a final self-position of the vehicle 1 on the basis of the evaluation result of the LiDAR self-position identification evaluation unit 7.

The self-position generation unit 73 employs the component of the first self-position evaluated to be valid by a matching result component analysis unit 72 of the LiDAR self-position identification evaluation unit 7, which will be described later, as a component of the final self-position of the vehicle 1.

The self-position generation unit 73 discards the component evaluated to be invalid by the matching result component analysis unit 72 of the LiDAR self-position identification evaluation unit 7 and employs the component of the second self-position identified on the basis of the second sensing data output from the internal sensor 21 as the component of the final self-position of the vehicle 1.

In a case where the matching itself has not been established, the final self-position of the vehicle 1 is the same as the second self-position.

The obstacle detection unit 8 acquires surrounding obstacle information of the vehicle 1 by using the sensing data acquired by the data acquisition unit 4.

The action planning unit 9 generates a global path by using the final self-position of the vehicle 1 generated by the self-position generation unit 73 and the map stored in the map DB 11. In addition, the action planning unit 9 generates a target movement path (local path) of the vehicle 1 by using the global path and the obstacle information acquired by the obstacle detection unit 8.

The motor control unit 10 generates a control signal of the motor 12 on the basis of the target movement path generated by the action planning unit 9.

The map DB 11 stores a map including a three-dimensional point cloud of a matching target used in the matching processing performed by the first self-position identification unit 5.

The storage unit 20 stores various programs including a series of programs for generating a final self-position.

(Configuration of Self-Position Identification Evaluation Unit)

As shown in FIG. 1, the LiDAR self-position identification evaluation unit 7 includes a high-matching part extraction unit 71 and a matching result component analysis unit 72.

The high-matching part extraction unit 71 extracts a part showing a high matching rate, i.e., a high-matching part by using the result of the matching processing performed by the first self-position identification unit 5.

Specifically, the high-matching part extraction unit 71 acquires, for example, a result indicating that matching has been established at a plurality of parts, and extracts a part (high-matching part) showing a matching rate equal to or higher than a threshold from the plurality of parts. The threshold is set in advance.

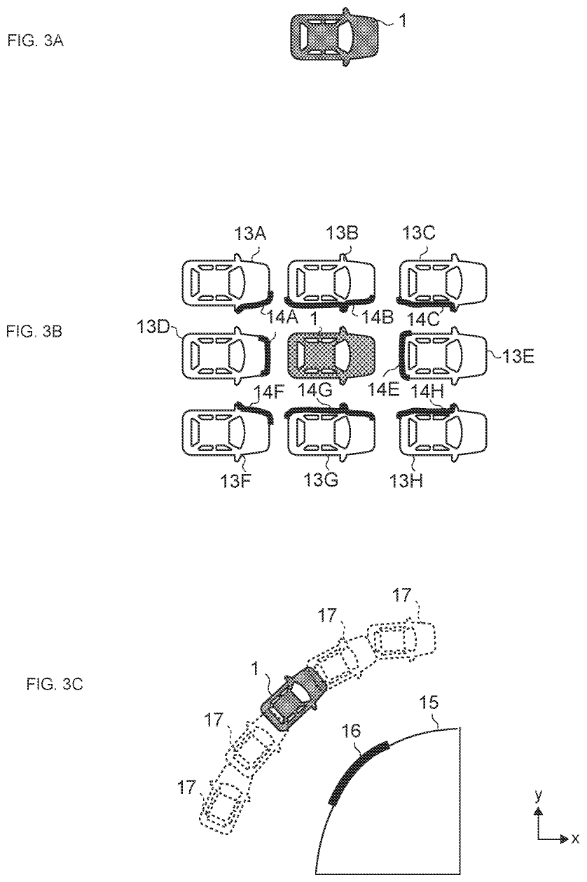

It should be noted that for example, as shown in FIG. 3A, in an environment where features that can be detected by the LiDAR 22 are not present around the vehicle 1, the matching processing is not established and matched parts are zero.

In a case where a plurality of high-matching parts has been extracted by the high-matching part extraction unit 71, the matching result component analysis unit 72 evaluates whether or not it is valid for each component of the X-axis component, the Y-axis component, the Z-axis component, the roll-axis rotation component, the pitch-axis rotation component, and the yaw-axis rotation component of the first self-position.

The component of the first self-position evaluated to be valid is employed when the self-position generation unit 73 in the subsequent stage generates a final self-position.

The component of the first self-position evaluated to be invalid is discarded and is not employed when the self-position generation unit 73 in the subsequent stage generates a final self-position. The component of the second self-position is instead employed as the component of the final self-position.

For example, variance can be used for evaluating whether or not each component is valid. In evaluating whether or not the component is valid, it is determined whether or not the component to be evaluated is uniquely determined.

When evaluating using the variance, the matching result component analysis unit 72 calculates variance for each component of the X-axis component, the Y-axis component, the Z-axis component, the roll-axis rotation component, the pitch-axis rotation component, and the yaw-axis rotation component with respect to the plurality of extracted high-matching parts.

In a case where the variance is smaller than a preset threshold, the matching result component analysis unit 72 evaluates the component as valid. On the other hand, in a case where the variance is equal to or larger than the threshold, the matching result component analysis unit 72 evaluates the component as invalid.

A general variance formula can be used to calculate the variance.

Moreover, whether each component is valid or invalid may be evaluated on the basis of whether or not the plurality of extracted high-matching parts is all present within a predetermined range for each component. For example, whether or not it is valid may be evaluated on the basis of whether or not a predetermined range from one high-matching part of the plurality of extracted high-matching parts includes all other high-matching parts.

In a case where the matching result is zero and the matching itself has not been established, the matching result component analysis unit 72 evaluates that there are no valid components.

By evaluating the validity of each component of the first self-position estimated on the basis of the outputs of the LiDAR 22 by using the matching processing result as described above, it is possible to determine in real time the featureless environment where the self-position identification accuracy lowers. Therefore, it is unnecessary to suppose a situation where the accuracy lowers in advance by simulations or the like.

Moreover, for example, even in the same featureless environment, valid components may differ depending on the environment. In the present technology, the validity of the component of the first self-position is evaluated for each component, and regarding the valid component, the component of the first self-position having a higher accuracy than the second self-position is employed, to thereby generate the final self-position. Accordingly, it is possible to generate a self-position with a relatively high accuracy even in the featureless environment, and to continuingly generate a self-position of the vehicle also when the environment changes.

It should be noted that in a case where it is determined that the highly accurate matching is not performed, an error may be notified to the driver of the vehicle 1, such that, for example, the processing related to the self-position generation can be stopped and the autonomous driving system based on the self-position identification can be stopped.

### Self-Position Generation Example

Next, self-position generation examples will be described, showing specific environment examples.

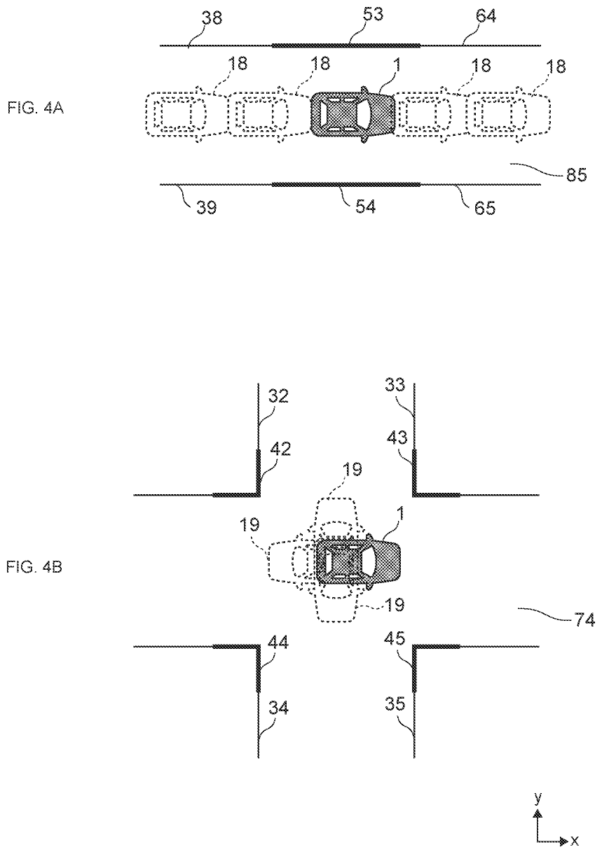

FIGS. 3 and 4 are schematic diagrams for describing various environment examples in which the vehicle 1 is placed and are all diagrams of the vehicle 1 as viewed from above.

### First Example 1

As described above, in the environment example shown in FIG. 3 (A) in which features that can be observed by the LiDAR 22 are not present around the vehicle 1, the matching processing is not established and the matched parts are zero.

In such a featureless environment example in which surrounding features are scarce and point clouds sufficient for matching cannot be obtained, the matching itself is not established, so it is determined that there are no valid components.

In this case, components of the second self-position identified by using the second sensing data from the internal sensor 21 are employed as all components of the final self-position of the vehicle 1.

### Second Example 2

FIG. 3 (B) is an example in which vehicles 13A to 13H are located around the vehicle 1. In such an environment example, three-dimensional point clouds (observed three-dimensional point clouds) 14A to 14H representing some of the surrounding vehicles 13A to 13H as the first sensing data output from the LiDAR 22 mounted on the vehicle 1 are obtained. However, a laser beam emitted from the LiDAR 22 may not reach a part indicating a point cloud of a matching target. Such an environment can be a featureless environment where features that can be observed by the LiDAR 22 to be used in matching processing for the self-position identification are not present.

In such an environment example in which it is surrounded by moving objects and static features enough to identify the self-position cannot be observed by the LiDAR 22, the matching itself is not established, so it is determined that there are no valid components.

In this case, the components of the second self-position identified by using the second sensing data from the internal sensor 21 are employed as all the components of the final self-position of the vehicle 1.

### Third Example 3

FIG. 3 (C) is a partial schematic diagram of a rotary intersection as viewed from above. FIG. 3 (C) is an example in which the vehicle 1 along an island 15 having a circular shape at the center of the rotary intersection is turning and traveling, and is an example of an environment where features can be observed by the LiDAR 22 are few. The reference sign 16 denotes a three-dimensional point cloud observed by the LiDAR 22 of the vehicle 1.

In the example shown in FIG. 3 (C), when the self-position of the vehicle 1 is identified on the basis of the first sensing data from the LiDAR 22, matching is established not only at the position of the vehicle 1 located on the line extending parallel along the curve portion of the island 15 but also at the positions of vehicles 17 indicated as the broken lines in the matching processing. As described above, the matching between the observed three-dimensional point cloud and the three-dimensional point cloud of the matching target may have a high matching rate at a plurality of parts.

In this example, in identifying the self-position of the vehicle 1, a plurality of solutions exists in each of the X-axis component, the Y-axis component, and the yaw-axis rotation component in the matching processing, and the variance is equal to or larger than the threshold in the matching result component analysis unit 72, and these components are evaluated to be invalid. Then, the self-position generation unit 73 employs the X-axis component, the Y-axis component, and the yaw-axis rotation component of the second self-position, which have been identified on the basis of the output of the internal sensor 21, as the X-axis component, the Y-axis component, and the yaw-axis rotation component of the final self-position of the vehicle 1.

It should be noted that in an environment where the LiDAR 22 can observe the ground in a case of estimating a self-position three-dimensionally, the roll-axis rotation component and the pitch-axis rotation component are uniquely determined, so the variance is smaller than the threshold and the matching result component analysis unit 72 evaluates the roll-axis rotation component and the pitch-axis rotation component as valid. Then, the self-position generation unit 73 may employ the roll-axis rotation component and the pitch-axis rotation component of the first self-position as the roll-axis rotation component and the pitch-axis rotation component of the final self-position.

### Fourth Example 4

FIG. 4 (A) is an environment example in which the shape of the road 85 is straight and the left and right walls 64 and 65 on the opposite sides of the road 85 are located extending straight in parallel to each other. An example in which the extending direction of the road 85 and the traveling direction of the vehicle 1 are parallel to each other is shown. A point cloud of the matching target representing the left wall 64 with respect to the traveling direction of the vehicle 1 is denoted by the reference sign 38 and a point cloud of the matching target representing the right wall 65 is denoted by the reference sign 39. In the figure, the thick lines indicate the three-dimensional point clouds 53 and 54 observed by the LiDAR 22 mounted on the vehicle 1.

In the example shown in FIG. 4 (A), although the walls 64 and 65 that are features to be matched are sufficiently present, their shapes are uniform with respect to the traveling direction of the vehicle 1.

In the example shown in FIG. 4 (A), when the first self-position of the vehicle 1 is identified on the basis of the first sensing data from the LiDAR 22, matching is established not only at the position of the vehicle 1 located on the line extending parallel along the walls 64 and 65 but also at the positions of vehicles 18 indicated as the broken lines in the matching processing. Therefore, the matching between the observed three-dimensional point cloud and the three-dimensional point cloud of the matching target has a high matching rate at a plurality of parts in the traveling direction.

In this example, in identifying the self-position of the vehicle 1 by using the matching processing, a plurality of solutions exists in the X-axis component in the matching processing, and the variance is equal to or larger than the threshold in the matching result component analysis unit 72, and the X-axis component is evaluated to be invalid. On the other hand, the Y-axis component and the yaw-axis rotation component that are uniquely determined are evaluated to be valid because the variance is smaller than the threshold in the matching result component analysis unit 72. Then, the self-position generation unit 73 employs the component of the second self-position, which has been identified on the basis of the output of the internal sensor 21, as the X-axis component of the final self-position of the vehicle 1. The components of the first self-position identified on the basis of the outputs of the LiDAR 22 are employed as the Y-axis component and the yaw-axis rotation component.

It should be noted that in an environment where the LiDAR 22 can observe the ground in a case of estimating a self-position three-dimensionally, the roll-axis rotation component and the pitch-axis rotation component are uniquely determined, so the variance is smaller than the threshold and the matching result component analysis unit 72 evaluates the roll-axis rotation component and the pitch-axis rotation component as valid. Then, the self-position generation unit 73 may employ the roll-axis rotation component and the pitch-axis rotation component of the first self-position as the roll-axis rotation component and the pitch-axis rotation component of the final self-position.

### Fifth Example 5

FIG. 4B is a schematic diagram of cross roads 74 as viewed from above and shows an environment example in which walls 32 to 35 that are features to be matched are sufficiently present, though their shapes are repeating patterns with respect to the yaw direction as viewed from the center of the cross roads 74. In FIG. 4 (B), thick lines 42 to 45 denote three-dimensional point clouds observed by the LiDAR 22 mounted on the vehicles 1, respectively.

In the example shown in FIG. 4 (B), in identifying the first self-position of the vehicle 1 on the basis of the first sensing data from the LiDAR 22, matching is established not only at the position of the vehicle 1 but also at the positions of the vehicles 19 oriented in a negative X-axis direction, a positive Y-axis direction, and a negative Y-axis direction, respectively, indicated by the broken lines, in the matching processing. In this case, a high matching rate at four parts in the yaw-axis rotation direction.

Therefore, the yaw-axis rotation component of the first self-position is evaluated to be invalid in the matching result component analysis unit 72 because the variance is equal to or larger than the threshold. On the other hand, the X-axis component and the Y-axis component are uniquely determined, so the variance is smaller than the threshold in the matching result component analysis unit 72 and the X-axis component and the Y-axis component are evaluated to be valid. Then, the self-position generation unit 73 employs the yaw-axis rotation component of the second self-position, which has been identified on the basis of the output of the internal sensor 21, as the yaw-axis rotation component of the final self-position of the vehicle 1. The X-axis component and the Y-axis component of the first self-position identified on the basis of the outputs of the LiDAR 22 are employed as the X-axis component and the Y-axis component.

It should be noted that in an environment where the LiDAR 22 can observe the ground in a case of estimating a self-position three-dimensionally, the roll-axis rotation component and the pitch-axis rotation component are uniquely determined, so the variance is smaller than the threshold and the matching result component analysis unit 72 evaluates the roll-axis rotation component and the pitch-axis rotation component as valid. Then, the self-position generation unit 73 may employ the roll-axis rotation component and the pitch-axis rotation component of the first self-position as the roll-axis rotation component and the pitch-axis rotation component of the final self-position.

[Self-Position Generation Method]

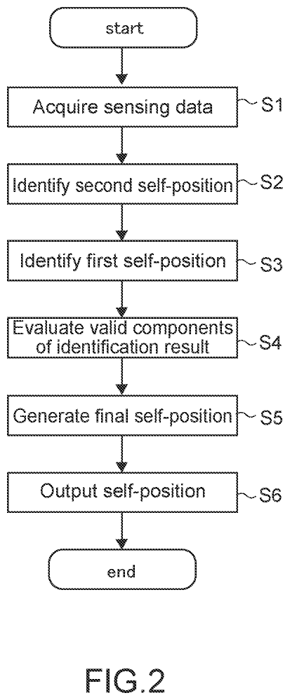

Next, a self-position generation method as an information processing method will be described with reference to the flow of FIG. 2.

When the self-position generation processing is started, the data acquisition unit 4 acquires second sensing data output from the internal sensor 21 and first sensing data output from the LiDAR 22 (S1). The second sensing data is output to the second self-position identification unit 6. The first sensing data is output to the first self-position identification unit 5.

Next, the second self-position identification unit 6 identifies a second self-position of the vehicle 1 on the basis of the second sensing data (S2). Information regarding the second self-position is output to the LiDAR self-position identification evaluation unit 7.

Next, the first self-position identification unit 5 performs matching processing of the observed three-dimensional point cloud, which is the first sensing data, and the three-dimensional point cloud, which is the matching target stored in the map DB 11, to thereby identify the first self-position of the vehicle 1 (S3). The matching processing result and the first self-position information are output to the LiDAR self-position identification evaluation unit 7.

Next, the LiDAR self-position identification evaluation unit 7 extracts a high-matching part on the basis of the result of the matching processing. Moreover, in a case where a plurality of high-matching parts is extracted, the LiDAR self-position identification evaluation unit 7 evaluates whether or not each of components in the extracted high-matching parts is valid (S4).

Next, the self-position generation unit 73 generates a final self-position of the vehicle 1 on the basis of the validity evaluation result for each component (S5). That is, the component of the first self-position is employed with respect to the component evaluated to be valid and the component of the second self-position is employed with respect to the component evaluated to be invalid, to thereby generate the final self-position of the vehicle 1.

Next, the self-position generation unit 73 outputs the generated final self-position to the action planning unit 9 (S6).

Thus, in generating the final self-position of the vehicle 1, the environment where the vehicle 1 is placed is taken into consideration and from which self-position of the second self-position and the first self-position, which have been identified by using the sensing data output from each of the internal sensor 21 and the LiDAR 22 that have different robustness, the component is to be employed is determined for each component.

Accordingly, it is possible to continuingly generate a self-position even in a featureless space.

### Second Embodiment

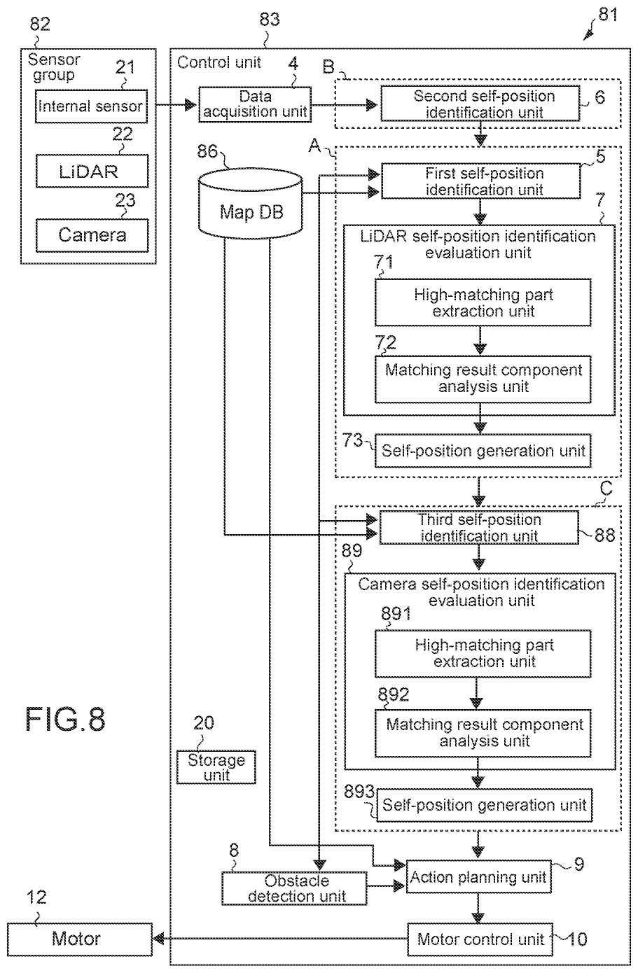

In this embodiment, a case where self-position identification is performed by using a camera as a sensor will be shown as an example and described with reference to FIG. 8. The same configurations as those of the first embodiment will be denoted by similar reference signs and the descriptions will be sometimes omitted. FIG. 8 is a block diagram showing functional configurations of a vehicle 81 in this embodiment.

As shown in FIG. 8, the vehicle 81 includes a sensor group 82, a control unit 83, and a motor 12.

The sensor group 82 includes an internal sensor 21, a LiDAR 22, a stereo camera 23 (hereinafter, referred to as camera), and the like.

The control unit 83 identifies a self-position of the vehicle 81 and controls the movement of the vehicle 81 in accordance with various programs stored in the storage unit 20. It will be described in detail later.

The camera 23 as a third sensor is a surrounding recognition sensor for obtaining surrounding environmental information of the vehicle 81. The camera 23 is installed in the vehicle 81, for example, so as to be capable of omni-directional detection. The camera 23 acquires image data as third sensing data that is surrounding information.

The camera 23 is provided, for example, at the position of at least one of a front nose, side mirrors, a rear bumper, or a back door of the vehicle, an upper part of a windshield in a vehicle compartment, or the like. The camera provided in the front nose and the camera provided in the upper part of the windshield in the vehicle compartment mainly acquire images of an area in front of the vehicle. The cameras provided in the side mirrors mainly acquires images of areas on the sides of the vehicle. The camera provided in the rear bumper or the back door mainly acquires images of an area behind the vehicle. The camera provided in the upper part of the windshield in the vehicle compartment is used mainly to detect preceding vehicles, pedestrians, obstacles, traffic signals, traffic signs, lanes, and the like.

The object detection is mainly performed by using the image data obtained from the camera 23. A third self-position of the vehicle 81 can be identified by performing matching processing of the image data acquired by the camera 23 and image data for matching stored in advance in a map DB 86 to be described later.

In this embodiment, the sensing data each acquired by the internal sensor 21, the LiDAR 22, and the camera 23 are used in generating a final self-position of the vehicle 81. In this embodiment, when the final self-position of the vehicle 1 is generated, the environment where the vehicle 81 is placed is taken into consideration and from which self-position of a second self-position, a first self-position, and a third self-position, which have been identified by using the sensing data output from each of the internal sensor 21, the LiDAR 22, and the camera 23 that have different robustness, the component is to be employed is determined for each component.

In FIG. 8, a module including the second self-position identification unit 6 that identifies the second self-position by using second sensing data output from the internal sensor 21 will be referred to as a second module B.

A module including a first self-position identification unit 5 that identifies the first self-position by using first sensing data output from the LiDAR 22, a LiDAR self-position identification evaluation unit 7 as a first evaluation unit, and a self-position generation unit 73 will be referred to as a first module A.

A module including a third self-position identification unit 88 that identifies the third self-position by using third sensing data output from the camera 23, a camera self-position identification evaluation unit 89 as a third evaluation unit, and a self-position generation unit 893 will be referred to as a third module C.

The second module B identifies a second self-position.

Information regarding the second self-position identified by the second module B is output to the first module A.

The first module A identifies the first self-position by matching processing using the first sensing data. In addition, in the first module A, whether or not the component of the first self-position is valid for each component is evaluated on the basis of the matching processing result, and the self-position is generated by using the evaluation result, information regarding the first self-position, and information regarding the second self-position.

Information regarding the self-position generated by the first module A is output to the third module C.

The third module C identifies the third self-position by matching processing using the third sensing data. In addition, the third module C evaluates whether or not the component of the third self-position is valid for each component on the basis of the matching processing result, and generates a final self-position by using the evaluation result, information regarding the third self-position, and the information regarding the self-position generated by the first module A.

In this manner, a plurality of modules that calculates self-position identification results different in accuracy may be configured in multiple stages and the final self-position may be generated by using valid components thereof. In this embodiment, these modules are arranged in series in the order of the second module B, the first module A, and the third module C.

The second module B located at the uppermost stage uses the second sensing data output from a wheel encoder and an IMU, which are internal sensors 21 having a lower self-position identification accuracy and higher robustness, are used.

The sensing data output from the internal sensors 21 is unlikely to be affected by environmental changes, and has higher robustness even in the featureless space. On the other hand, accumulated errors occur.

The first module A located in the middle stage uses the first sensing data output from the LiDAR 22 having moderate self-position identification accuracy and robustness. As described above, although the LiDAR 22 has a higher accuracy than the internal sensor, the LiDAR 22 has low robustness in the featureless environment, is easily affected by weather and the like, and has lower robustness to environmental changes than the internal sensor.

The third module C located at the lowest stage uses the third sensing data output from the camera 23, which has a higher self-position identification accuracy but is only available under certain environmental conditions. The camera 23 has lower robustness in the featureless environment.

In the matching processing using the image data as the third sensing data, the degree of matching of image features is evaluated between the image data observed by the camera 23 and the image data of the matching target registered on the map in advance and they are correlated with each other.

Therefore, in the self-position identification using the image data, in a case where characteristic features to be matched are sufficiently present in the surrounding environment of the vehicle 81, highly accurate self-position identification can be performed. However, the self-position identification accuracy is lower in the featureless environment. Under the certain environmental conditions that characteristic features are present, the camera 23 is a sensor that is more robust to observe than the LiDAR 22 because it is unlikely to be affected by weather.

As described above, in this embodiment, the control unit is configured by providing the modules such that the accuracy of the sensing data to be used becomes higher toward the subsequent stage.

In such a configuration, with respect to a component of the third self-position identified by the third module C, which has been evaluated to be invalid, the component of the self-position generated by the first module A is employed as the component of the final self-position.

The first module A employs a component of the first self-position identified by the first module A, which has been evaluated to be valid, and employs a component of the second self-position as a component evaluated to be invalid to thereby generate a self-position.

Therefore, with respect to a component evaluated to be invalid in both the first module A and the third module C, a component of the second self-position is employed as the component of the final self-position.

As described above, it is favorable that the module having higher robustness in the featureless environment is located at the uppermost stage.

As shown in FIG. 8, the control unit 83 includes a data acquisition unit 4, a first self-position identification unit 5, a second self-position identification unit 6, a LiDAR self-position identification evaluation unit 7 as a first evaluation unit, a self-position generation unit 73, an obstacle detection unit 8, an action planning unit 9, a motor control unit 10, a storage unit 20, a map DB 86, a third self-position identification unit 88, a camera self-position identification evaluation unit 89 as a third evaluation unit, and a self-position generation unit 893.

The data acquisition unit 4 acquires the second sensing data output from the internal sensor 21, the first sensing data output from the LiDAR 22, and the third sensing data output from the camera 23.

The acquired first sensing data (data output from the LiDAR) is output to the first self-position identification unit 5.

The acquired second sensing data (data output from the internal sensor) is output to the second self-position identification unit 6.

The acquired third sensing data (data output from the camera) is output to the third self-position identification unit 88. Hereinafter, the third sensing data will be sometimes referred to as observed image data.

The map DB 86 stores a map including a three-dimensional point cloud of a matching target used in the matching processing performed by the first self-position identification unit 5 and image data of a matching target used in the matching processing performed by the third self-position identification unit 88.

The third self-position identification unit 88 identifies the third self-position of the vehicle 81 on the basis of the third sensing data acquired by the data acquisition unit 4 (data output from the camera).

Specifically, the third self-position identification unit 88 performs exhaustive matching processing on the observed image data and the image data of the matching target stored in the map DB 86 in the search area to identify the third self-position of the vehicle 81.

Information regarding the matching processing result and the third self-position is output to the camera self-position identification evaluation unit 89.

The third self-position includes a roll-axis rotation component, a pitch-axis rotation component, a yaw-axis rotation component, and the like related to attitude information as well as an X-axis component, a Y-axis component, and a Z-axis component related to the position information.

The first self-position identification unit 5, the second self-position identification unit 6, and the third self-position identification unit 88 each identify the self-position of the vehicle 81 by using the sensing data output for each different sensor.

The camera self-position identification evaluation unit 89 evaluates whether or not the component of the third self-position is valid for each component on the basis of the result of the matching processing performed in identifying the third self-position by the third self-position identification unit 88.

The camera self-position identification evaluation unit 89 includes a high-matching part extraction unit 891 and a matching result component analysis unit 892.

The high-matching part extraction unit 891 extracts a point showing a high matching rate, i.e., a high-matching part, by using the matching processing result performed by the third self-position identification unit 88.

Specifically, the high-matching part extraction unit 891 acquires, for example, a result indicating that matching has been established at a plurality of parts and extracts a point (high-matching part) indicating a matching rate equal to or higher than a threshold from the plurality of parts. The threshold is set in advance.

It should be noted that for example, in a case where characteristic features are not present around the vehicle 81, the matching processing is not established and the matched parts are zero.

In a case where a plurality of high-matching parts has been extracted by the high-matching part extraction unit 891, the matching result component analysis unit 892 evaluates whether or not it is valid for each component of the X-axis component, the Y-axis component, the Z-axis component, the roll-axis rotation component, the pitch-axis rotation component, and the yaw-axis rotation component of the third self-position.

The component of the third self-position evaluated to be valid is employed when the self-position generation unit 893 in the subsequent stage generates a self-position.

The component of the third self-position evaluated to be invalid is discarded and is not employed when the self-position generation unit 893 in the subsequent stage generates a self-position. The component of the self-position generated by the first module A is instead employed as the component of the final self-position.

The method shown in the first embodiment can be used for evaluating whether or not each component is valid.

In a case where the matching result is zero and the matching itself has not been established, the matching result component analysis unit 892 evaluates that there are no valid components.

The self-position generation unit 893 generates a final self-position of the vehicle 81 on the basis of the evaluation result of the matching result component analysis unit 892.

The self-position generation unit 893 employs the component of the third self-position evaluated to be valid by the matching result component analysis unit 892, as the component of the final self-position of the vehicle 81.

The self-position generation unit 893 discards the component of the third self-position evaluated to be invalid by the matching result component analysis unit 892, and employs the component of the self-position generated by the first module A as the component of the final self-position of the vehicle 81.

As described above, the final self-position is generated. The generated self-position is output to the action planning unit 9.

As described above, when generating the final self-position of the vehicle 81, the environment where the vehicle 81 is placed is taken into consideration and from which self-position of the second self-position, the first self-position, and the third self-position, which have been identified by using the respective sensing data of the internal sensor 21, the LiDAR 22, and the camera 23 that have different robustness, the component is to be employed is determined for each component.

Accordingly, it is possible to continuingly generate a self-position even in a featureless space.

### Third Embodiment

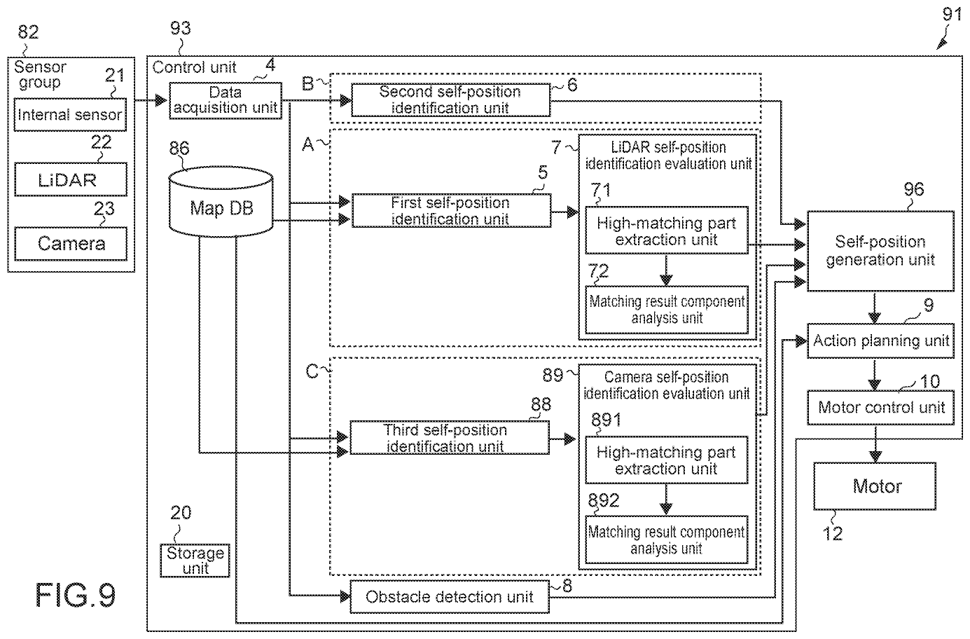

In this embodiment, a case where self-position identification is performed by further using a camera as a sensor as in the second embodiment will be shown as example. The description will be given with reference to FIG. 9. The same configurations as those of the second embodiment will be denoted by similar reference signs and the descriptions will be sometimes omitted. In this embodiment, configurations different from those of the second embodiment will be mainly described.

FIG. 9 is a block diagram showing functional configurations of a vehicle 91 in this embodiment.

In the second embodiment, the example has been described in which the second module B, the first module A, and the third module C are arranged in series, though these modules may be arranged in parallel as shown in FIG. 9.

In the second embodiment, the self-position generation unit is provided in each of the first module A and the third module C, though in this embodiment, the self-position generation unit is not provided in each module. In this embodiment, a self-position generation unit 96 is provided separately from the respective modules.

The information regarding the first self-position identified by the first module A and the matching processing result used in the first self-position identification, the information regarding the second self-position identified by the second module B, the information regarding the third self-position identified by the third module C, and the matching processing result used in the third self-position identification are output to the self-position generation unit 96.

As shown in FIG. 9, the vehicle 91 includes a sensor group 82, a control unit 93, a motor 12.

The sensor group 82 includes an internal sensor 21, a LiDAR 22, a camera 23, and the like.

The control unit 93 identifies a self-position of the vehicle 91 and controls the movement of the vehicle 91 in accordance with various programs stored in a storage unit 20.

Also in this embodiment, as in the second embodiment, in generating the final self-position, the environment where the vehicle 91 is placed is taken into consideration and from which self-position of the second self-position, the first self-position, and the third self-position, which have been identified by using the respective sensing data of the internal sensor 21, the LiDAR 22, and the camera 23 that have different robustness, the component is to be employed is determined for each component.

Accordingly, it is possible to continuingly generate a self-position even in a featureless space.

In FIG. 9, a module including a second self-position identification unit 6 that identifies a self-position by using the second sensing data output from the internal sensor 21 will be referred to as the second module B.

A module including a first self-position identification unit 5 that identifies the first self-position by using the first sensing data output from the LiDAR 22 and a LiDAR self-position identification evaluation unit 7 will be referred to as the first module A.

A module including a third self-position identification unit 88 that identifies a third self-position by using the third sensing data output from the camera 23 and a camera self-position identification evaluation unit 89 will be referred to as the third module C.

The control unit 93 includes a data acquisition unit 4, the first self-position identification unit 5, the second self-position identification unit 6, the LiDAR self-position identification evaluation unit 7, an obstacle detection unit 8, an action planning unit 9, a motor control unit 10, the storage unit 20, a map DB 86, the third self-position identification unit 88, the camera self-position identification evaluation unit 89, and the self-position generation unit 96.

The information regarding the second self-position identified by the second self-position identification unit 6 is output to the self-position generation unit 96.

The validity evaluation result for each component of the first self-position evaluated by the LiDAR self-position identification evaluation unit 7 and the information regarding the first self-position identified by the first self-position identification unit 5 are output to the self-position generation unit 96.

The validity evaluation result for each component of the third self-position evaluated by the camera self-position identification evaluation unit 89 and the information regarding the third self-position identified by the third self-position identification unit 88 are output to the self-position generation unit 96.

The self-position generation unit 96 integrates the information regarding the first self-position, the information regarding the second self-position, and the information regarding the third self-position by, for example, Kalman filtering or the like on the basis of the validity evaluation result of each component of the first self-position and the validity evaluation result of each component of the third self-position, and generates a final self-position.

In generation of the final self-position, with respect to a component of components of the third self-position, which has been evaluated to be valid, the component of the third self-position is employed as the component of the final self-position. With respect to a component of components of the third self-position, which has been evaluated to be invalid, which is a component of components of the first self-position, which has been evaluated to be valid, the component of the first self-position is employed as the component of the final self-position. With respect to a component evaluated to be invalid in both the third self-position and the first self-position, a component of the second self-position is employed.

The generated self-position is output to the action planning unit 9.

It should be noted that for example, the self-position generation unit 96 may output to the third self-position identification unit 88 a result of the self-position in which the information regarding the first self-position and the information regarding the second self-position are integrated on the basis of the validity evaluation result of each component of the first self-position. The third self-position identification unit 88 may identify the third self-position by using the result of the integrated self-position as a hint. In this manner, a configuration in which the previous integrated self-position result is input into each self-position identification unit from the self-position generation unit 96 as a hint may be employed.

Embodiments of the present technology are not limited to the above-mentioned embodiments, and various modified examples can be made without departing from the gist of the present technology.

For example, in the embodiments described above, the example in which the control unit 3, 83, or 93 that performs the series of processing for generating the final self-position is provided in the vehicle which is the movable object has been described, though it may be provided in an external information processing apparatus other than the movable object, for example, provided on a cloud server.

Moreover, for example, in the embodiments described above, the vehicle that is the four-wheeled motor vehicle has been described as an example of the movable object, though the present technology not limited thereto and can be used for other movable objects in general. For example, the present technology can be applied to movable objects such as motorcycles, two-wheeled differential drive robots, multi-legged robots, and drones movable in a three-dimensional space.

Moreover, in the embodiments described above, the example in which the roll-axis rotation component, the yaw-axis rotation component, and the pitch-axis rotation component are used as the attitude information (rotation information) has been described, though data in quaternion representation may be used as the attitude information.

Moreover, in the embodiments described above, for example, the first sensing data is used to identify the first self-position, though the identified second self-position may be additionally used as a hint to identify the first self-position. Thus, in identifying the self-position on the basis of the output of one sensor, the self-position identified on the basis of the output of another sensor may be used as a hint to identify the self-position.

Moreover, in the second and third embodiments described above, the example in which the modules are provided corresponding to the respective sensing data of the camera and the LiDAR, and the modules and these modules are configured in multiple stages has been described, though not limited thereto.

For example, sensing data from the same sensor may be used to identify the self-position by utilizing the same self-position identification algorithm, though a plurality of modules having different parameters of the algorithm may be provided and configured in multiple stages. That is, even with the same sensor and the same self-position identification algorithm, different self-position identification results can be obtained by changing the performance by changing the parameters (observation range, resolution, matching threshold, map to be matched) of the algorithm. Therefore, a plurality of modules that calculates self-position identification results at different accuracy, using the same sensing data but different algorithm parameters, may be provided, and the final self-position may be generated by utilizing their valid components.

Alternatively, the sensing data to be used may be data that has been locally pre-processed in each of the individual sensors included in the sensor group, called processed data, or data that has not been locally pre-processed, called raw data (unprocessed data, primary data).

In a case where the processed data is used, since pre-processing has been performed locally and extra information such as noise has been omitted, processing can be performed at a relatively high speed with less burden on subsequent processing.

On the other hand, in a case where the raw data is used, since the pre-processing has not been performed locally, data having a large amount of information is output as compared with the case of using the processed data, and more accurate results can be calculated in the subsequent processing.

Alternatively, for some sensors of the plurality of sensors, the raw data may be output as the sensing data and the processed data may be output and used as data other than the sensing data.

It should be noted that the present technology may also take the following configurations.

(1) An information processing apparatus, including:

a first self-position identification unit that identifies a first self-position of a movable object on the basis of first sensing data; and

an evaluation unit that evaluates whether or not each component of the identified first self-position is valid.

(2) The information processing apparatus according to (1), further including

a self-position generation unit that employs a component evaluated to be valid by the evaluation unit and generates a final self-position of the movable object.

(3) The information processing apparatus according to (2), further including

a second self-position identification unit that identifies a second self-position of the movable object on the basis of the second sensing data different from the first sensing data, in which

the self-position generation unit replaces the component determined to be invalid by the evaluation unit with a component of the second self-position identified by the second self-position identification unit and generates the final self-position of the movable object.

(4) The information processing apparatus according to (3), in which

the first sensor that outputs the first sensing data and the second sensor that outputs the second sensing data are different from each other.

(5) The information processing apparatus according to (4), in which

the second sensor has higher robustness in a featureless environment than the first sensor.

(6) The information processing apparatus according to (4) or (5), in which

the second sensor is an internal sensor mounted on the movable object.

(7) The information processing apparatus according to any one of (4) to (6), in which

the first sensor is light detection and ranging (LiDAR) mounted on the movable object.

(8) The information processing apparatus according to any one of (1) to (7), in which

the first self-position identification unit identifies the first self-position on the basis of a matching processing result between a point cloud of a surrounding environment of the movable object, which is the first sensing data, and a point cloud for matching, which is acquired in advance.

(9) The information processing apparatus according to (8), in which

the evaluation unit evaluates whether or not each of components of the first self-position is valid by using the matching processing result.

(10) The information processing apparatus according to any one of (1) to (9), in which

the evaluation unit discards a component evaluated to be invalid.

(11) An information processing apparatus, including:

a first module including
a first self-position identification unit that identifies a first self-position of a movable object on the basis of a first sensing data and
a first evaluation unit that evaluates whether or not each component of the identified first self-position is valid;

a second module including a second self-position identification unit that identifies the second self-position of the movable object on the basis of the second sensing data;

a third module including
a third self-position identification unit that identifies a third self-position of the movable object on the basis of the third sensing data and
a third evaluation unit that evaluates whether or not each component of the identified third self-position is valid; and

a self-position generation unit that generates the final self-position of the movable object by using evaluation results of the first evaluation unit and the third evaluation unit, the first self-position, the second self-position, and the third self-position.

(12) An information processing apparatus, including:

a second module including a second self-position identification unit that identifies a second self-position of a movable object on the basis of second sensing data;

a first module including
a first self-position identification unit that identifies the first self-position of the movable object on the basis of first sensing data,
a first evaluation unit that evaluates whether or not each component of the identified first self-position is valid, and
a self-position generation unit that generates a self-position of the movable object by using an evaluation result of the first evaluation unit, the first self-position, and the second self-position; and

a third module including
a third self-position identification unit that identifies the third self-position of the movable object on the basis of the third sensing data,
a third evaluation unit that evaluates whether or not each component of the identified third self-position is valid, and
a self-position generation unit that generates the final self-position of the movable object by using an evaluation result of the third evaluation unit, the third self-position, and a self-position generated by the first module.

(13) An information processing apparatus according to (11) or (12), in which

the first sensor that outputs the first sensing data, the second sensor that outputs the second sensing data, and a third sensor that outputs the third sensing data are different from one another.

(14) The information processing apparatus according to (13), in which

the first sensor is light detection and ranging (LiDAR) mounted on the movable object, the second sensor is an internal sensor mounted on the movable object, and the third sensor is a camera mounted on the movable object.

(15) An information processing method, including:

identifying a first self-position of a movable object on the basis of first sensing data; and

evaluating whether or not each component of the identified first self-position is valid.

(16) A program that causes an information processing apparatus to execute processing including the steps of:

identifying a first self-position of a movable object on the basis of first sensing data; and

evaluating whether or not each component of the identified first self-position is valid.

### REFERENCE SIGNS LIST

1, 81, 91 vehicle (information processing apparatus)
5 first self-position identification unit
6 second self-position identification unit
7, 87 LiDAR self-position identification evaluation unit (evaluation unit, first evaluation unit)
21 internal sensor (first sensor)
22 LiDAR (second sensor)
23 camera (third sensor)
73, 96, 893 self-position generation unit
88 third self-position identification unit
89 camera self-position identification evaluation unit (third evaluation unit)
A first module
B second module
C third module

1. An information processing apparatus, comprising:
a first self-position identification unit that identifies a first self-position of a movable object on a basis of first sensing data; and
an evaluation unit that evaluates whether or not each component of the identified first self-position is valid.

2. The information processing apparatus according to claim 1, further comprising
a self-position generation unit that employs a component evaluated to be valid by the evaluation unit and generates a final self-position of the movable object.

3. The information processing apparatus according to claim 2, further comprising
a second self-position identification unit that identifies a second self-position of the movable object on a basis of the second sensing data different from the first sensing data, wherein
the self-position generation unit replaces the component determined to be invalid by the evaluation unit with a component of the second self-position identified by the second self-position identification unit and generates the final self-position of the movable object.

4. The information processing apparatus according to claim 3, wherein
the first sensor that outputs the first sensing data and the second sensor that outputs the second sensing data are different from each other.

5. The information processing apparatus according to claim 4, wherein
the second sensor has higher robustness in a featureless environment than the first sensor.

6. The information processing apparatus according to claim 4, wherein
the second sensor is an internal sensor mounted on the movable object.

7. The information processing apparatus according to claim 4, wherein
the first sensor is light detection and ranging (LiDAR) mounted on the movable object.

8. The information processing apparatus according to claim 1, wherein
the first self-position identification unit identifies the first self-position on a basis of a matching processing result between a point cloud of a surrounding environment of the movable object, which is the first sensing data, and a point cloud for matching, which is acquired in advance.

9. The information processing apparatus according to claim 8, wherein
the evaluation unit evaluates whether or not each component of the first self-position is valid by using the matching processing result.

10. The information processing apparatus according to claim 1, wherein
the evaluation unit discards a component evaluated to be invalid.

11. An information processing apparatus, comprising:
a first module including
a first self-position identification unit that identifies a first self-position of a movable object on a basis of a first sensing data and
a first evaluation unit that evaluates whether or not each component of the identified first self-position is valid;
a second module including a second self-position identification unit that identifies the second self-position of the movable object on a basis of the second sensing data;
a third module including
a third self-position identification unit that identifies a third self-position of the movable object on a basis of the third sensing data and
a third evaluation unit that evaluates whether or not each component of the identified third self-position is valid; and
a self-position generation unit that generates the final self-position of the movable object by using evaluation results of the first evaluation unit and the third evaluation unit, the first self-position, the second self-position, and the third self-position.

12. An information processing apparatus, comprising:
a second module including a second self-position identification unit that identifies a second self-position of a movable object on a basis of second sensing data;
a first module including
a first self-position identification unit that identifies the first self-position of the movable object on a basis of first sensing data,
a first evaluation unit that evaluates whether or not each component of the identified first self-position is valid, and
a self-position generation unit that generates a self-position of the movable object by using an evaluation result of the first evaluation unit, the first self-position, and the second self-position; and
a third module including
a third self-position identification unit that identifies the third self-position of the movable object on a basis of the third sensing data,
a third evaluation unit that evaluates whether or not each component of the identified third self-position is valid, and
a self-position generation unit that generates the final self-position of the movable object by using an evaluation result of the third evaluation unit, the third self-position, and a self-position generated by the first module.

13. An information processing apparatus according to claim 11, wherein
the first sensor that outputs the first sensing data, the second sensor that outputs the second sensing data, and a third sensor that outputs the third sensing data are different from one another.

14. The information processing apparatus according to claim 13, wherein
the first sensor is light detection and ranging (LiDAR) mounted on the movable object, the second sensor is an internal sensor mounted on the movable object, and the third sensor is a camera mounted on the movable object.

15. An information processing method, comprising:
identifying a first self-position of a movable object on a basis of first sensing data; and
evaluating whether or not each component of the identified first self-position is valid.

16. A program that causes an information processing apparatus to execute processing comprising the steps of:
identifying a first self-position of a movable object on a basis of first sensing data; and
evaluating whether or not each component of the identified first self-position is valid.
